(19) United States
(12) Patent Application Publication
(10) Pub. No.: US 2022/0049650 A1
(43) Pub. Date: Feb. 17, 2022

(54) RELIEF VALVE FOR A TURBOCHARGER AND PROCESS FOR MANUFACTURING A RELIEF VALVE

(71) Applicants: MAHLE Metal Leve S/A, Jundiai-SP (BR); MAHLE International GmbH, Stuttgart (DE)

(72) Inventors: Rafael Bettini Rabello, Sumare-SP (BR); Pedro Lerman, Rafaela Santa Fe (AR); Samantha Uehara, Sao Paulo-SP (BR)

(21) Appl. No.: 17/275,811

(22) PCT Filed: Sep. 12, 2019
(86) PCT No.: PCT/BR2019/050393

§ 371 Date: Mar. 12, 2021

(30) Foreign Application Priority Data
Sep. 12, 2018 (BR) 10 2018 068 426 4

(51) Int. Cl. F02C 6/12; B21K 1/20; C22C 19/05; C22C 38/40

(52) U.S. Cl. CPC F02C 6/12; B21K 1/20; C22C 19/058; C22C 38/40; F05D 2220/40; F05D 2300/171; F05D 2230/239; F05D 2230/25; F05D 2230/313; F05D 2230/314; F05D 2230/41; F05D 2230/10

(57) ABSTRACT

The present invention relates to a relief valve (1) for a turbocharger, in which the crank arm (3) is made of a first material and the shaft (4) is made of a second material different from the first material used for manufacturing the crank arm (3), each of the materials containing a composition that provides the necessary properties according to the application of each component of the relief valve (1). The present invention also relates to a process for manufacturing the relief valve (1), which allows the crank arm (3) and the shaft (4) to be manufactured separately, using different materials for the manufacture of each component.

### CROSS REFERENCE TO RELATED APPLICATIONS

This application is a national stage application, filed under 35 U. S.C. § 371, of International Application No. PCT/BR2019/050393, filed Sep. 12, 2019, which international application claims priority to and the benefit of Brazilian Application No. BR102018068426-4, filed Sep. 12, 2018; the contents of both of which as are hereby incorporated by reference in their entireties.

### BACKGROUND

### Technical Field

The present invention refers to a relief valve for a turbocharger, in which the crank arm is made of a first material and the shaft is made of a second material different to the first material used for manufacturing the crank arm, each of the materials containing a composition that provides the necessary properties in accordance with the application of each component of the relief valve. The present invention also refers to a process for manufacturing a relief valve which enables the crank arm and the shaft to be manufactured separately, using different materials for the manufacture of each component

### Description of Related Art

The relief valves, also known as wastegate, are present in most automobiles that have a turbocharger. This valve is installed in the exhaust manifold and its function is to regulate the flow of gases that pass through the turbine. Its main objective is to prevent the turbine from turning too quickly, which would mean excess air in the motor. Its working is relatively simple: when the pressure of the gases attains the maximum regulated by the system, the valve opens and allows part of the gases to be diverted directly to the exhaust, not passing through the turbine.

In short, the turbocharger is a device that basically improves the performance of the internal combustion engine, boosting its output. It uses the exhaust gases, which are collected and turn the turbine at high temperatures. Next, the air passes through a small inlet where it is cooled and compressed jointly with the air sucked to the side of the turbocharger. This process, which goes from the hot side to the cold side, blows cooled air and, therefore, richer for the burning mixture of the motor.

In the hot half of the turbocharger, the gases reach high temperatures. High heat means high pressure, and it is at this moment that the relief valves enter into action. The relief valve is activated as soon as the desired pressure pre-set in the intake manifold is reached. At this moment, the valve opens and allows part of the exhaust gases to circumvent the turbine and be guided directly to the exhaust pipe, not using the energy present in the gases which did not pass through the turbocharger system.

This measure means the rotation of turbine is controlled, delivering a higher charge, besides guaranteeing that the pressure does not exceed the maximum working pressure, which prevents potential damage to the equipment. Accordingly, turbochargers which contain a relief valve enable the rotation and increase in pressure of the turbocharger to be controlled more effectively, optimizing the air rotation intake pressure in low rotations of the motor.

The relief valves can be internal or external and are basically composed of two parts: a valve flap and a support element, as illustrated in FIG. 2. This support element consists of a shaft, which is driven by an actuator, and a crank arm, which transfers movement to the valve flap.

The function of the relief valve flap is to seal the housing of the turbine and is directly subject to extremely high temperatures from the exhaust gases. Therefore, the valve flap should present excellent resistance to corrosion, resistance to high temperatures and deformation resistance.

The crank arm and the shaft of the relief valve are currently produced in a single body, forming the support element of the relief valve. While the crank arm should present excellent resistance to corrosion, to high temperatures and to deformation, the shaft should also present good tribological properties (dry contact with a bushing), such as resistance to wear and scuffing at high temperatures.

Both the valve flap and the support element, crank arm and shaft are usually produced by investment casting or, alternatively, by sintering, such that the most common material used to produce the components of the relief valve is composed of a nickel-based superalloy.

However, the high pressures applied in the investment casting process usually favor the formation of gaseous porosities. This formation of gaseous porosities reduces the resistance to breakage of the relief valve, particularly at the connecting portion between the crank arm and the shaft, considered the most critical portion of the valve and which is more subject to sustaining breakage.

Today, the support element formed by the crank arm and by the shaft is made of a single part and, therefore, using the same material both for manufacturing the crank arm and for manufacturing the shaft.

It is important to note, however, that these components are subject to different requests when working in a motor, such that the crank arm should present excellent resistance to corrosion and at high temperatures that vary between 800° C. and 1050° C., whereas the shaft should present excellent tribological performance when in contact with a counterpart, with good properties of attrition, wear and resistance to scuffing, under temperature variations between 350° C. and 600° C.

In view of the different requests to which the crank arm and the shaft are subject, it is necessary to obtain a relief valve in which the crank arm and the shaft are made of different materials specific to each application and which provide the necessary properties for the excellent working of each of the valve components.

Therefore, the objective of the present invention lies in providing a relief valve for a turbocharger in which the components that form the relief valve are made in separate parts, using different materials for the manufacture of each component.

It is also an objective of the present invention to provide a relief valve for a turbocharger formed by a valve flap and a support element, the support element being formed by a crank arm and a shaft, in which the crank arm is made of a first material and the shaft is made of a second material different to the first material used for manufacturing the crank arm.

Further, it is an objective of the present invention to provide a relief valve in which the crank arm and the shaft of the valve are associated by a process that provides high robustness to the connecting portion between the components, providing excellent resistance to breakage.

Moreover, it is an objective of the present invention to provide a process for obtaining a relief valve the enables the use of different materials for the crank arm and the shaft of the valve, said process being simpler and presenting reduced cost in relation to the processes of manufacturing relief valves used currently.

### BRIEF SUMMARY

The objectives of the present invention are achieved by a relief valve for a turbocharger formed by a valve flap and a support element, the support element being formed by a crank arm and a shaft, the crank arm being made of a first material and the shaft being made of a second material different to the first material used for manufacturing the crank arm, the first material used for manufacturing the crank arm being composed of a nickel-based material with at least 30% nickel by weight, preferably containing up to 0.08% carbon by weight, 0.5% silicon by weight, up to 0.5% manganese by weight, up to 0.015% phosphorus by weight, up to 0.01% sulphur by weight, between 13.5% and 15.5% chrome by weight, between 30% and 33.5% nickel by weight, between 0.4% and 1% molybdenum by weight, between 1.6% and 2.2% aluminum by weight and iron as residue; alternatively, the first material used for manufacturing the crank arm being composed of an austenitic stainless steel with at least 10% chrome by weight and 15% nickel by weight, preferably containing up to 0.15% carbon by weight, up to 0.75% silicon by weight, up to 2% manganese by weight, up to 0.045% phosphorus by weight, up to 0.03% sulphur by weight, between 24% and 26% chrome by weight, between 19% and 22% nickel by weight and iron as residue; the second material used for manufacturing the shaft being composed of a nickel-based material with at least 60% nickel by weight, preferably containing between 0.04% and 0.10% carbon by weight, up to 1% silicon by weight, up to 1% manganese by weight, up to 0.02% phosphorus by weight, up to 0.015% sulphur by weight, between 18% and 21% chrome by weight, at least 65% nickel by weight, between 1% and 1.8% aluminum by weight and up to 3% iron by weight; the valve flap being made with the first material used in the manufacture of the crank arm or with the second material used in the manufacture of the shaft, the valve flap, the crank arm and the shaft receiving a ceramic coating, PVD or CVD, or a nitriding treatment or a hardening treatment.

The objectives of the present invention are also achieved by a process for manufacturing a relief valve such as described above, the process comprising the steps of: i) forging or machining the crank arm and the shaft in separate parts; ii) carrying out an attrition welding connecting process for the association between the crank arm and the shaft; and iii) carrying out an attrition welding connecting process for the association between the crank arm and the shaft, in which a valve flap, the crank arm and the shaft receive a ceramic coating, PVD or CVD, or a nitriding treatment or a hardening treatment.

Moreover, the objectives of the present invention are achieved by a relief valve for a turbocharger formed by a valve flap and a support element, the support element being formed by a crank arm and a shaft, in which the valve is obtained by a process that comprises the steps of: i) forging the valve flap; ii) forging or machining the crank arm and the shaft in separate parts; and iii) carrying out an attrition welding connecting process for the association between the crank arm and the shaft.

### BRIEF DESCRIPTION OF THE FIGURES

The relief valve for a turbocharger of the present invention can be better understood by way of the following detailed description which is based on the drawings listed below:

FIG. 1—schematic representation of a turbocharger with indication of the installation position of the relief valve;

FIG. 2—representation of a relief valve with all the constituent parts;

FIG. 3—representation of the microstructure obtained in the connecting portion between the crank arm and the shaft of the relief valve of the present invention;

FIG. 4—representation of the valve flap of the relief valve of the present invention;

FIG. 5—representation of the valve flap of the relief valve of the present invention, illustrating the pin associated to the fastening component;

FIG. 6—representation of the microstructure obtained in the connecting portion between the crank arm and the shaft of the relief valve of the present invention; and

FIG. 7—graphic representation of the fatigue resistance achieved by a relief valve of the state of the art, represented by the letter A, and the relief valve of the present invention, represented by the letter B.

### DETAILED DESCRIPTION OF VARIOUS EMBODIMENTS

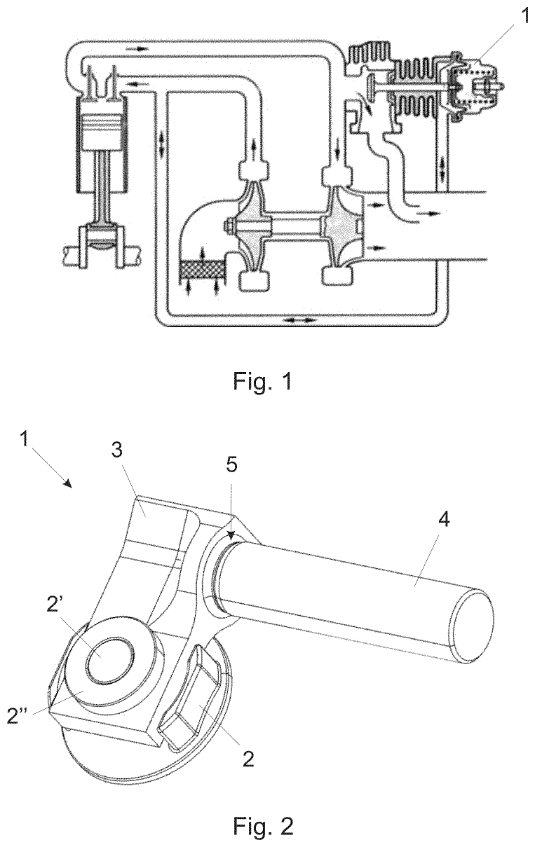

The present invention presents a relief valve 1 for a turbocharger in which the components that form the relief valve 1 are made in separate parts, using different materials for the manufacture of each component. FIG. 1 is a schematic representation of a turbocharger, indicating the position of the relief valve 1.

Usually, a relief valve is formed by basically two parts, namely a valve flap 2 and a support element, as illustrated in FIG. 2. This support element consists of a shaft 4 and a crank arm 3.

The relief valve 1 of the present invention presents the crank arm 3 being made of a first material and the shaft 4 being made of a second material different to the first material used for manufacturing the crank arm 3.

In a first preferred constructive configuration, the first material used for manufacturing the crank arm 3 is composed of a nickel-based material with at least 30% nickel by weight. Particularly, the crank arm 3 is made of a first material which contains up to 0.15% carbon by weight, up to 0.75% silicon by weight, up to 2% manganese by weight, up to 0.045% phosphorus by weight, up to 0.03% sulphur by weight, between 24% and 26% chrome by weight, between 19% and 22% nickel by weight and iron as residue.

In a second preferred constructive configuration, the first material used for manufacturing the crank arm 3 is composed of an austenitic stainless steel with at least 10% chrome by weight and 15% nickel by weight. Particularly, the crank arm 3 is made of a first material which contains up to 0.08% carbon by weight, 0.5% silicon by weight, up to 0.5% manganese by weight, up to 0.015% phosphorus by weight, up to 0.01% sulphur by weight, between 13.5% and 15.5% chrome by weight, between 30% and 33.5% nickel by weight, between 0.4% and 1% molybdenum by weight, between 1.6% and 2.2% aluminum by weight and iron as residue.

Regardless of the composition of the first material used for manufacturing the crank arm 3, the shaft 4 should necessarily be made of a second material different to the first material. Preferably, the second material used for manufacturing the shaft 4 is composed of a nickel-based material with at least 60% nickel by weight. Particularly, the shaft 4 is made of a second material containing between 0.04% 0.10% carbon by weight, up to 1% silicon by weight, up to 1% manganese by weight, up to 0.02% phosphorus by weight, up to 0.015% sulphur by weight, between 18% and 21% chrome by weight, at least 65% nickel by weight, between 1% and 1.8% aluminum by weight and up to 3% iron by weight.

The valve flap 2 is made of a first material, identical to the one used in the manufacture of the crank arm 3, or of a second material, identical to the one used in the manufacture of the shaft 4. The selection between the first or the second material for manufacturing the valve flap 2 varies according to each project and application.

Among the processes used for manufacturing the relief valve 1 of the present invention, forging and machining are prominent, followed by a connecting process carried out by attrition welding.

In a first preferred constructive configuration, the valve flap 2, the crank arm 3 and the shaft 4 are made separately by means of a forging process. The valve flap 2 and the crank arm 3 are associated by means of a pin, whereas the crank arm 3 and the shaft 4 are connected by a process of attrition welding.

The process of forging per se achieves superior mechanical properties compared to the process of investment casting, used in the state of the art, since it provides greater dislocation density and prevents the formation of microporosities, increasing the robustness of the components.

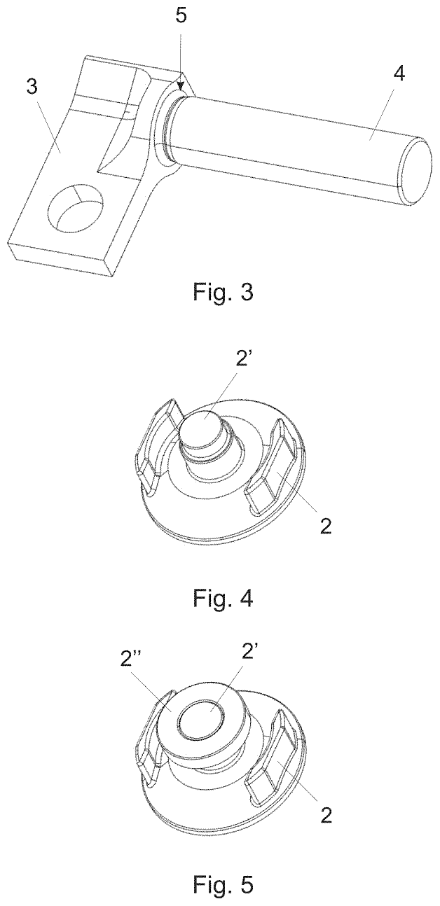

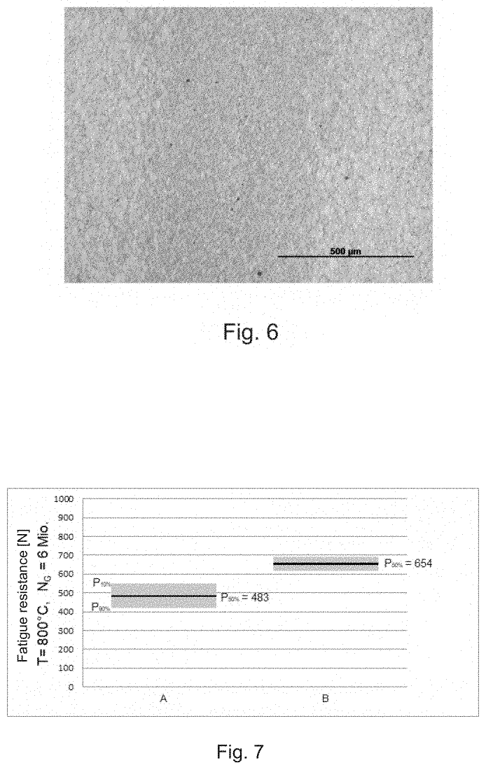

In turn, the process of attrition welding is capable of refining the microstructure of the connecting portion 5 between the crank arm 3 and the shaft 4, enhancing the mechanical properties in this connecting portion 5 and, chiefly, increasing the robustness against breakages. FIG. 3 illustrates the refined microstructure obtained in the connecting portion 5 subjected to the process of attrition welding.

Additionally, the fact that each one of the components of the valve is made separately enables the use of different materials in manufacturing the components, enabling the selection of optimized materials specifically for obtaining different properties.

For example, the first material selected for manufacturing the crank arm 3 achieves specific properties for providing an increase in resistance to high temperatures and resistance to corrosion. In contrast, the second material selected for manufacturing the shaft 4 provides specific tribological properties.

Alternatively, in a second preferred constructive configuration, the valve flap 2, the crank arm 3 and the shaft 4 are made separately by means of a process of machining, with the valve flap 2 and the crank arm 3 being associated by means of a pin, whereas the crank arm 3 and the shaft 4 are connected by a process of attrition welding.

The high resistance to breakage, obtained in the connecting portion 5 between the crank arm 3 and the shaft 4, is proven by carrying out a fatigue resistance test by using a vertical pulsating machine on a test bench.

For the test, a comparison was made of two relief valves having identical designs. However, for the relief valve 1 from the state of the art, indicated by letter A, a single material for manufacturing all the components that form the valve was used, and for the relief valve 1 of the present invention, indicated by letter B, a first material was used for manufacturing the crank arm 3 and a second material, different to the first material, for manufacturing the shaft 4, with the connection between the crank arm 3 and the shaft 4 being carried out by means of a process of attrition welding.

Furthermore, the relief valve of the state of the art (letter A) tested in the fatigue resistance test is obtained by means of an investment casting process, whereas the relief valve 1 of the present invention (letter B) is obtained by means of forging and/or machining process, followed by a process of attrition welding, such as described previously.

As can be noted in the graphic representation of the fatigue resistance test, illustrated in FIG. 7, valve A of the state of the art presented a survival probability of 50% when applying a force slightly over 480 Newton (N). In contrast, valve B of the present invention shows a survival probability of 50% when a force over 650 Newton (N) was applied.

The increase of fatigue resistance for valve B of the present invention in relation to valve A of the state of the art is therefore proven.

Besides the different materials used for manufacturing the valve flap 2, of the crank arm 3 and of the shaft 4 of the relief valve 1 of the present invention and the use of the manufacturing process of forging/machining and welding, the present invention further provides the application with a coating on the outer surface of each of the components of the valve 1, said coating comprising a ceramic coating, PVD or CVD, or a nitriding hardening treatment.

Said coatings, jointly with the materials and processes used for obtaining the relief valve 1 of the present invention guarantee excellent resistance and durability not only to the valve per se, but to the turbocharger as a whole, since it achieves improved working and performance of the valve 1.

In short, the relief valve 1 of the present invention presents greater resistance in relation to the valves of the state of the art, due to the possibility of using different materials, specific for each component of the valve 1, being obtained by means of simpler processes and which present reduced costs in relation to the processes used in the state of the art.

Having described examples of preferred embodiments, it should be understood that the scope of the present invention encompasses other possible variations, being limited solely by the content of the accompanying claims, potential equivalents being included therein.

1-15. (canceled)

16. A relief valve (1) for a turbocharger, the relief valve (1) comprising:
a valve flap (2); and
a support element, the support element being formed by a crank arm (3) and a shaft (4),
wherein:
the crank arm (3) is made of a first material; and
the shaft (4) is made of a second material different to the first material used for manufacturing the crank arm (3).

17. The relief valve (1) according to claim 16, wherein the first material used for manufacturing the crank arm (3) is composed of a nickel-based material with at least 30% nickel by weight.

18. The relief valve (1) according to claim 17, wherein the first material used for manufacturing the crank arm (3) contains up to 0.08% carbon by weight, 0.5% silicon by weight, up to 0.5% manganese by weight, up to 0.015% phosphorus by weight, up to 0.01% sulphur by weight, between 13.5% and 15.5% chrome by weight, between 30% and 33.5% nickel by weight, between 0.4% and 1% molybdenum by weight, between 1.6% and 2.2% aluminum by weight, and iron as residue.

19. The relief valve (1) according to claim 16, wherein the first material used for manufacturing the crank arm (3) is composed of an austenitic stainless steel with at least 10% chrome by weight and 15% nickel by weight.

20. The relief valve (1) according to claim 16, wherein the first material used for manufacturing the crank arm (3) contains up to 0.15% carbon by weight, up to 0.75% silicon by weight, up to 2% manganese by weight, up to 0.045% phosphorus by weight, up to 0.03% sulphur by weight, between 24% and 26% chrome by weight, between 19% and 22% nickel by weight, and iron as residue.

21. The relief valve (1) according to claim 16, wherein the second material used for manufacturing the shaft (4) is composed of a nickel-based material with at least 60% nickel by weight.

22. The relief valve (1) according to claim 16, wherein the second material used for manufacturing the shaft (4) contains between 0.04% 0.10% carbon by weight, up to 1% silicon by weight, up to 1% manganese by weight, up to 0.02% phosphorus by weight, up to 0.015% sulphur by weight, between 18% and 21% chrome by weight, at least 65% nickel by weight, between 1% and 1.8% aluminum by weight, and up to 3% iron by weight.

23. The relief valve (1) according to claim 16, wherein the valve flap (2) is made of the first material used in the manufacture of the crank arm (3).

24. The relief valve (1) according to claim 16, wherein the valve flap (2) is made of the second material used in the manufacture of the shaft (4).

25. The relief valve (1) according to claim 16, wherein the valve flap (2), the crank arm (3) and the shaft (4) receive a ceramic coating, PVD or CVD, or a nitriding treatment or a hardening treatment.

26. A process for manufacturing the relief valve (1) as defined in claim 16, the process comprising the steps of:
forging the valve flap (2);
forging the crank arm (3) and the shaft (4) in separate parts; and
carrying out an attrition welding connecting process for the association between the crank arm (3) and the shaft (4).

27. The process according to claim 26, wherein the valve flap (2), the crank arm (3) and the shaft (4) receive a ceramic coating, PVD or CVD, or a nitriding treatment or a hardening treatment.

28. A process for manufacturing the relief valve (1) as defined in claim 16, the process comprising the steps of:
forging the valve flap (2);
machining of crank arm (3) and the shaft (4) in separate parts; and
carrying out an attrition welding connecting process for the association between the crank arm (3) and the shaft (4).

29. The process according to claim 28, wherein the valve flap (2), the crank arm (3) and the shaft (4) receive a ceramic coating PVD or CVD, or a nitriding treatment or a hardening treatment.

30. A relief valve (1) for a turbocharger formed by a valve flap (2) and a support element, the support element being formed by a crank arm (3) and a shaft (4), wherein the relief valve is obtained by a process comprising the steps of:
forging the valve flap (2);
forging or machining the crank arm (3) and the shaft (4) in separate parts; and
carrying out an attrition welding connecting process for the association between the crank arm (3) and the shaft (4).
